(19) United States
(12) Patent Application Publication
(10) Pub. No.: US 2003/0087122 A1
(43) Pub. Date: May 8, 2003

(54) Weldable high strength Al-Mg-Si alloy product

(76) Inventors: Rinze Benedictus, Delft (NL); Guido Weber, Andernach (DE); Alfred Johann Peter Haszler, Vallendar (DE); Christian Joachim Keidel, Montabaur (DE)

Correspondence Address: STEVENS, DAVIS, MILLER & MOSHER, LLP, Suite 850, 1615 L Street NW, Washington, DC, 20036, US

(21) Appl. No.: 10/189,252

(22) Filed: Jul. 5, 2002

(30) Foreign Application Priority Data
Jul. 9, 2001 (EP) 01202639.9

(51) Int. Cl. C22C 21/04; B32B 15/01

(52) U.S. Cl. 428/654; 148/694; 148/417; 420/534

(57) ABSTRACT

The invention relates to a weldable, high-strength aluminum alloy rolled product containing the elements, in weight percent, Si 0.8 to 1.3, Cu 0.2 to 0.45, Mn 0.5 to 1.1, Mg 0.45 to 1.0, Fe 0.01 to 0.3, Zr<0.25, Cr<0.25, Zn<0.35, Ti<0.25, V<0.25, others each <0.05 and total <0.15, balance aluminum, and further with the proviso that the weight percent of “available Si” is in the range of 0.86 to 1.15, preferably in the range of 0.86 to 1.05. The weight percentage (“wt. %”) of “available Si” is calculated according to the equation:

wt. % Si(available)=wt. % Si−(wt. % Fe+wt. % Mn)/6

### FIELD OF THE INVENTION

The invention relates to an aluminum alloy product suitable for use in aircraft, automobiles, and other applications and a method of producing such an aluminum alloy product. More specifically, it relates to an improved weldable aluminum product, particularly useful in aircraft applications, having high damage tolerant characteristics, including improved corrosion resistance, formability, fracture toughness and increased strength properties.

### DESCRIPTION OF THE RELATED ART

It is known in the art to use heat treatable aluminum alloys in a number of applications involving relatively high strength such as aircraft fuselages, vehicular members and other applications. Aluminum alloys 6061 and 6063 are well known heat treatable aluminum alloys. These alloys have useful strength and toughness properties in both T4 and T6 tempers. As is known, the T4 condition refers to a solution heat treated and quenched condition naturally aged to a substantially stable property level, whereas T6 tempers refer to a stronger condition produced by artificially ageing. These known alloys lack, however, sufficient strength for most structural aerospace applications. Several other Aluminum Association (“AA”) 6000 series alloys are generally unsuitable for the design of commercial aircraft, which require different sets of properties for different types of structures. Depending on the design criteria for a particular airplane component, improvements in strength, fracture toughness and fatigue resistance result in weight savings, which translate to fuel economy over the lifetime of the aircraft, and/or a greater level of safety. To meet these demands several 6000 series alloys have been developed.

European patent no. EP-0173632 concerns extruded or forged products of an alloy consisting of the following alloying elements, in weight percent:

Si 0.9-1.3, preferably 1.0-1.15

Mg 0.7-1.1, preferably 0.8-1.0

Cu 0.3-1.1, preferably 0.8-1.0

Mn 0.5-0.7

Zr 0.07-0.2, preferably 0.08-0.12

Fe <0.30

Zn 0.1-0.7, preferably 0.3-0.6

balance aluminum and unavoidable impurities (each <0.05, total <0.15).

The products have a non-recrystallised microstructure. This alloy has been registered under the AA designation 6056.

It has been reported that this known AA6056 alloy is sensitive to intercrystalline corrosion in the T6 temper condition. In order to overcome this problem U.S. Pat. No. 5,858,134 provides a process for the production of rolled or extruded products having the following composition, in weight percent:

Si 0.7-1.3

Mg 0.6-1.1

Cu 0.5-1.1

Mn 0.3-0.8

Zr <0.20

Fe <0.30

Zn <1

Ag <1

Cr <0.25

other elements <0.05, total <0.15

balance aluminum,

and whereby the products are brought in an over-aged temper condition. However, over-ageing requires time and money consuming processing times at the end of the manufacturer of aerospace components. In order to obtain the improved intercrystalline corrosion resistance it is essential for this process that in the aluminum alloy the Mg/Si ratio is less than 1.

U.S. Pat. No. 4,589,932 discloses an aluminum wrought alloy product for e.g. automotive and aerospace constructions, which alloy was subsequently registered under the AA designation 6013, having the following composition, in weight percent:

Si 0.4-1.2, preferably 0.6-1.0

Mg 0.5-1.3, preferably 0.7-1.2

Cu 0.6-1.1

Mn 0.1-1.0, preferably 0.2-0.8

Fe <0.6

Cr <0.10

Ti <0.10

the balance aluminum and unavoidable impurities.

The aluminum alloy has the mandatory proviso that [Si+0.1]<Mg<[Si+0.4], and has been solution heat treated at a temperature in a range of 549 to 582° C. and approaching the solidus temperature of the alloy. In the examples illustrating the patent the ratio of Mg/Si is always more than 1.

U.S. Pat. No. 5,888,320 discloses a method of producing an aluminum alloy product. The product has a composition of, in weight percent:

Si 0.6-1.4, preferably 0.7-1.0

Fe<0.5, preferably <0.3

Cu<0.6, preferably <0.5

Mg 0.6-1.4, preferably 0.8-1.1

Zn 0.4 to 1.4, preferably 0.5-0.8

at least one element selected from the group:

Mn 0.2-0.8, preferably 0.3-0.5

Cr 0.05-0.3, preferably 0.1-0.2

balance aluminum and unavoidable impurities.

The disclosed aluminum alloy provides an alternative for the known high-copper containing 6013 alloy, and whereby a low-copper level is present in the alloy and the zinc level has been increased to above 0.4 wt. % and which is preferably in a range of 0.5 to 0.8 wt. %. The higher zinc content is required to compensate for the loss of copper.

In spite of these references, there is still a great need for an improved aluminum base alloy product having improved balance of strength, fracture toughness and corrosion resistance.

### SUMMARY OF THE INVENTION

It is an object of the invention to provide an improved and weldable 6000-series aluminum alloy rolled product having a lower Cu-content than the known 6013 alloy, while still achieving a high strength.

It is a further object of the invention to provide an improved and weldable 6000-series aluminum alloy rolled product having a lower Cu-content than the known 6013 alloy, while achieving an ultimate tensile strength of at least 355 MPa in a T6 temper.

It is yet a further object of the invention to provide an improved and weldable 6000-series aluminum alloy rolled product having a lower Cu-content than the known 6013 alloy, while achieving an ultimate tensile strength of at least 355 MPa in a T6 temper in combination with a better intergranular corrosion performance than standard 6013 alloy.

According to the invention there is provided a weldable, high-strength aluminum alloy rolled product containing the elements, in weight percent, Si 0.8 to 1.3, Cu 0.2 to 0.45, Mn 0.5 to 1.1, Mg 0.45 to 1.0, Fe 0.01 to 0.3, Zr<0.25, Cr<0.25, Zn<0.35, Ti<0.25, V<0.25, others each <0.05 and total <0.15, balance aluminum, and further with the proviso that the weight percent of available Si is in the range of 0.86 to 1.15, preferably in the range of 0.86 to 1.05. The weight percentage (“wt. %”) of available Si is calculated according to the equation:

wt. % Si(available)=wt. % Si−(wt. % Fe+wt. % Mn)/6

By the invention we can provide an improved and weldable AA6000-series aluminum alloy rolled product having a good balance in strength, fracture toughness and corrosion resistance, and intergranular corrosion resistance in particular. The alloy product has a lower Cu-content than standard 6013 alloys or standard 6056 alloys, while still providing sufficiently high strength levels in combination with an improved intergranular corrosion performance compared to standard 6013 alloys and/or 6056 alloys when tested in the same temper. With the alloy product according to the invention we can provide a product having an 0.2% yield strength of 325 MPa or more and an ultimate tensile strength of 355 MPa or more. The alloy product may be welded successfully using techniques like e.g. laser beam welding, friction-stir welding and TIG-welding.

The product can either be naturally aged to produce an improved alloy product having good formability in the T4 temper or artificially aged to a T6 temper to produce an improved alloy having high strength and fracture toughness, along with good corrosion resistance properties. A good balance in strength and corrosion performance it being obtained without a need for bringing the product to an over-aged temper, but by careful selection of narrow ranges for the Cu, Mg, Si, and Mn-contents and such that there is sufficient Si available in a defined range as strengthening element.

The balance of high formability, good fracture toughness, high strength, and good corrosion resistance properties of the weldable aluminum alloy of the present invention are dependent upon the chemical composition that is closely controlled within specific limits in more detail as set forth below. All composition percentages are by weight percent.

A preferred range for the silicon content is from 1.0 to 1.15% to optimize the strength of the alloy in combination with magnesium. A too high Si content has a detrimental influence on the elongation in the T6 temper and on the corrosion performance of the alloy. As set out above the available silicon is preferably in a range of 0.86 to 1.05 to achieve the best balance in strength and corrosion performance. A too low Si content, and thereby a low amount of available silicon, does not provide sufficient strength to the alloy.

Magnesium in combination with the silicon provides strength to the alloy. The preferred range of magnesium is 0.6 to 0.85%, and more preferably 0.6 to 0.75%. At least 0.45% magnesium is needed to provide sufficient strength while amounts in excess of 1.0% make it difficult to dissolve enough solute to obtain sufficient age hardening precipitate to provide high T6 strength.

Copper is an important element for adding strength to the alloy. However, too high copper levels in combination with Mg have a detrimental influence of the corrosion performance and on the weldability of the alloy product. The preferred copper content is in the range of 0.3 to 0.45% as a compromise in strength, toughness, formability and corrosion performance. It has been found that in this range the alloy product has a good resistance against IGC.

The preferred range of manganese is 0.6 to 0.78%, and more preferably 0.65 to 0.78%. Mn contributes to or aids in grain size control during operations that can cause the alloy to recrystallize, and contributes to increase strength and toughness.

The zinc content in the alloy according to the invention should be less than 0.35%, and preferably less than 0.2%. It has been reported in U.S. Pat. No. 5,888,320 that the addition of zinc may add to the strength of the aluminum alloy, but in accordance with the invention it has been found that too high zinc contents have a detrimental effect of the intergranular corrosion performance of the product. Furthermore, the addition of zinc tends to produce an alloy having undesirable higher density, which is in particular disadvantageous when the alloy is being applied for aerospace applications.

Iron is an element having a strong influence on the formability and fracture toughness of the alloy product. The iron content should be in the range of 0.01 to 0.3%, and preferably 0.01 to 0.25%, and more preferably 0.01 to 0.2%.

Titanium is an important element as a grain refiner during solidification of the rolling ingots, and should preferably be less than 0.25%. In accordance with the invention it has been found that the corrosion performance, in particular against intergranular corrosion, can be remarkably be improved by having a Ti-content in the range of 0.06 to 0.20%, and preferably 0.07 to 0.16%. It has been found that the Ti may be replaced in part or in whole by vanadium.

Zirconium and/or chromium and/or hafnium may be added to the alloy each in an amount of less than 0.25% to improve the recrystallization behavior and/or the corrosion performance (in particular IGC) of the alloy. At too high levels the Cr present may form undesirable large particles with the Mg in the alloy product.

The balance is aluminum and inevitable impurities. Typically each impurity element is present at 0.05% maximum and the total of impurities is 0.15% maximum.

The best results are achieved when the alloy rolled products have a recrystallized microstructure, meaning that 80% or more, and preferably 90% or more of the grains in a T4 or T6 temper are recrystallized.

The product according to the invention is preferably therein characterized that the alloy having been aged to the T6 temper in an ageing cycle which comprises exposure to a temperature of between 150 and 210° C. for a period between 1 and 20 hours, thereby producing an aluminum alloy product having a yield strength of 325 MPa or more, and preferably of 330 MPa or more, and an ultimate tensile strength of 355 MPa or more, and preferably of 365 MPa or more.

Furthermore, the product according to the invention is preferably therein characterized that the alloy having been aged to the T6 temper in an ageing cycle which comprises exposure to a temperature of between 150 and 210° C. for a period between 1 and 20 hours, thereby producing an aluminum alloy product having an intergranular corrosion after a test according to MIL-H-6088 present to a depth of less than 180 μm, and preferably to a depth of less than 150 μm.

In an embodiment the invention also consists in that the product of this invention may be provided with at least one cladding. Such clad products utilize a core of the aluminum base alloy product of the invention and a cladding of usually higher purity in particularly corrosion protecting the core. The cladding includes, but is not limited to, essentially unalloyed aluminum or aluminum containing not more than 0.1 or 1% of all other elements. Aluminum alloys herein designated 1xxx-type series include all Aluminum Association (AA) alloys, including the sub-classes of the 1000-type, 1100-type, 1200-type and 1300-type. Thus, the cladding on the core may be selected from various Aluminum Association alloys such as 1060, 1045, 1100, 1200, 1350, 1170, 1175, 1180, or 1199. In addition, alloys of the AA7000-series alloys, such as 7072 containing zinc (0.8 to 1.3%), can serve as the cladding and alloys of the AA6000-series alloys, such as AA6003 or AA6253, which contain typically more than 1% of alloying additions, can serve as cladding. Other alloys could also be useful as cladding as long as they provide in particular sufficient overall corrosion protection to the core alloy.

In addition, a cladding of the AA4000-series alloys can serve as cladding. The AA4000-series alloys have as main alloying element silicon typically in the range of 6 to 14%. In this embodiment the clad layer provides the welding filler material in a welding operation, e.g. by means of laser beam welding, and thereby overcoming the need for the use of additional filler wire materials in a welding operation. In this embodiment the silicon content is preferably in a range of 10 to 12%.

The clad layer or layers are usually much thinner than the core, each constituting 2 to 15 or 20 or possibly 25% of the total composite thickness. A cladding layer more typically constitutes around 2 to 12% of the total composite thickness.

In a preferred embodiment the alloy product according to the invention is being provided with a cladding thereon on one side of the AAIOOO-series and on the other side thereon of the AA4000-series. In this embodiment corrosion protection and welding capability are being combined. In this embodiment the product may be used successfully for example for pre-curved panels. In case the rolling practice of an asymmetric sandwich product (1000-series alloy+core+4000-series alloy) causes some problems such as banaring, there is also the possibility of first rolling a symmetric sandwich product having the following subsequent layers 1000-series alloy+4000-series alloy+core alloy+4000-series alloy+1000-series alloy, where after one or more of the outer layer(s) are being removed, for example by means of chemical milling.

The invention also consists in a method of manufacturing the aluminum alloy product according to the invention. The method of producing the alloy product comprises the sequential process steps of: (a) providing stock having a chemical composition as set out above, (b) preheating or homogenizing the stock, (c) hot rolling the stock, (d) optionally cold rolling the stock, (e) solution heat treating the stock, and (f) quenching the stock to minimize uncontrolled precipitation of secondary phases. Thereafter the product can be provided in a T4 temper by allowing the product to naturally age to produce an improved alloy product having good formability, or can be provided in a T6 temper by artificial ageing. To artificial age, the product in subjected to an ageing cycle comprising exposure to a temperature of between 150 and 210° C. for a period between 0.5 and 30 hours.

The aluminum alloy as described herein can be provided in process step (a) as an ingot or slab for fabrication into a suitable wrought product by casting techniques currently employed in the art for cast products, e.g. DC-casting, EMC-casting, EMS-casting.

Typically, prior to hot rolling the rolling faces of both the clad and the non-clad products are scalped in order to remove segregation zones near the cast surface of the ingot.

The cast ingot or slab may be homogenized prior to hot rolling and/or it may be preheated followed directly by hot rolling. The homogenization and/or preheating of the alloy prior to hot rolling should be carried out at a temperature in the range 490 to 580° C. in single or in multiple steps. In either case, the segregation of alloying elements in the material as cast is reduced and soluble elements are dissolved. If the treatment is carried out below 490° C., the resultant homogenization effect is inadequate. If the temperature is above 580° C., eutectic melting might occur resulting in undesirable pore formation. The preferred time of the above heat treatment is between 2 and 30 hours. Longer times are not normally detrimental. Homogenization is usually performed at a temperature above 540° C. A typical preheat temperature is in the range of 535 to 560° C. with a soaking time in a range of 4 to 16 hours.

After the alloy product is cold rolled, or if the product is not cold rolled then after hot rolling, the alloy product is solution heat treated at a temperature in the range of 480 to 590° C., preferably 530 to 570° C., for a time sufficient for solution effects to approach equilibrium, with typical soaking times in the rang of 10 sec. to 120 minutes. With clad products, care should be taken against too long soaking times to prevent diffusion of alloying element from the core into the cladding that can detrimentally affect the corrosion protection afforded by said cladding.

After solution heat treatment, it is important that the alloy product be cooled to a temperature of 175° C. or lower, preferably to room temperature, to prevent or minimize the uncontrolled precipitation of secondary phases, e.g. Mg₂Si. On the other hand cooling rates should not be too high in order to allow for a sufficient flatness and low level of residual stresses in the alloy product. Suitable cooling rates can be achieved with the use of water, e.g. water immersion or water jets.

The product according to the invention has been found to be very suitable for application as a structural component of an aircraft, in particular as aircraft fuselage skin material, preferably having a thickness of up to 15 mm.

### EXAMPLES

### Example 1

Six different alloys have been DC-cast into ingots, then subsequently scalped, pre-heated for 6 hours at 550° C. (heating-up speed about 30° C./h), hot rolled to a gauge of 7.5 mm, cold rolled to a final gauge of 2.0 mm, solution heat treated for 15 min. at 550° C., water quenched, aged to a T6-temper by holding for 4 hours at 190° C. (heat-up speed about 35° C./h), followed by air cooling to room temperature. Table 1 gives the chemical composition of the alloys cast, balance inevitable impurities and aluminum, and whereby Alloy no. 1 and 4 are alloys according to the invention and the other alloys are for comparison.

The tensile testing and intergranular corrosion (“IGC”) testing have been carried out on the bare sheet material in the T6-temper and having a fully recystallised microstructure. For the tensile testing in the L-direction small euro-norm specimens were used, average results of 3 specimens are given, and whereby “Rp” stands for yield strength, “Rm” for ultimate tensile strength, and A50 for elongation. The “TS” stands for tear strength, and has been measured in the L-T direction in accordance with ASTM-B871-96. Intergranular corrosion (“ICG”) was tested on two specimens of 50×60 mm in accordance with the procedure given in AIMS 03-04-000, which specifies MIL-H-6088 and some additional steps. The maximum depth in microns has been reported in Table 3.

From the test results in Table 2 and 3 it can be seen that from a comparison of Alloy 1 and 2 that a too high Si-content in the aluminum alloy has an adverse effect on the TS, and in particular the maximum intergranular corrosion depth is significantly increased. From a comparison of Alloy 1 and 3 it can be seen that a too high Zn-content in the aluminum alloy has an adverse effect on the maximum intergranular corrosion depth. From a comparison of Alloy 1 with standard alloys 6056 and 6013 in a T6-temper it can be seen that the alloy product according to the invention has a significantly better performance in intergranular corrosion at the trade-off the somewhat lower tensile properties. The lower TS of the alloy product according to the invention compared to standard 6056 and 6013 is due to a significantly lower Cu-content in the aluminum alloy. From a comparison of Alloy 1 and 4 (both according to the invention) it can be seen that an increase in the Ti-content in the aluminum alloy product results in a remarkable reduction of the maximum intergranular corrosion depth.

### Example 2

On an industrial scale a DC-cast ingot has been made and having a chemical composition as listed in Table 4 and designated as Alloy 5, balance inevitable impurities and aluminium. The ingot has been scalped subsequently to a gauge of 400 mm, then heated for homogenisation using a heat-up rate of 3⁰° C./hour for homogenisation for 6 hours at 570° C. followed by 10 hours at 580° C., and allowed to cool by air cooling, then pre-heated for 6 hours at 510° C., hot rolled to a gauge of 8 mm, cold rolled to a gauge of 4.8 mm, solution heat treated for 140 min. at 550° C., water quenched, 1.5% cold stretched, aged to a T6-temper by holding for 4 hours at 190° C. (heat-up speed about 36° C./hour), followed by air cooling to room temperature. The rolled sheets had a final gauge of 4.77 mm.

The tensile testing and intergranular corrosion (“IGC”) testing have been carried out on the bare sheet material in the T6-temper and having a fully recystallised microstructure. For the tensile testing in the L-direction and LT-direction small euro-norm specimens were used, average results of 3 specimens are given, and whereby “Rp” stands for yield strength, “Rm” for ultimate tensile strength, and A50 for elongation. The results are summarised in Table 5. Intergranular corrosion resistance (“ICG”) was tested on two specimens of 50×60 mm in accordance with the procedure given in AIMS 03-04-000, which specifies MIL-H-6088 and some additional steps. The maximum depth in microns was 103 microns.

Furthermore the stress corrosion resistance has been measured in accordance with ASTM G-47, in the LT-direction, with constant strain, a tension load, and a stress level of 300 MPa. It has been found that after 45 days of testing the samples still did not fail after which the testing was stopped.

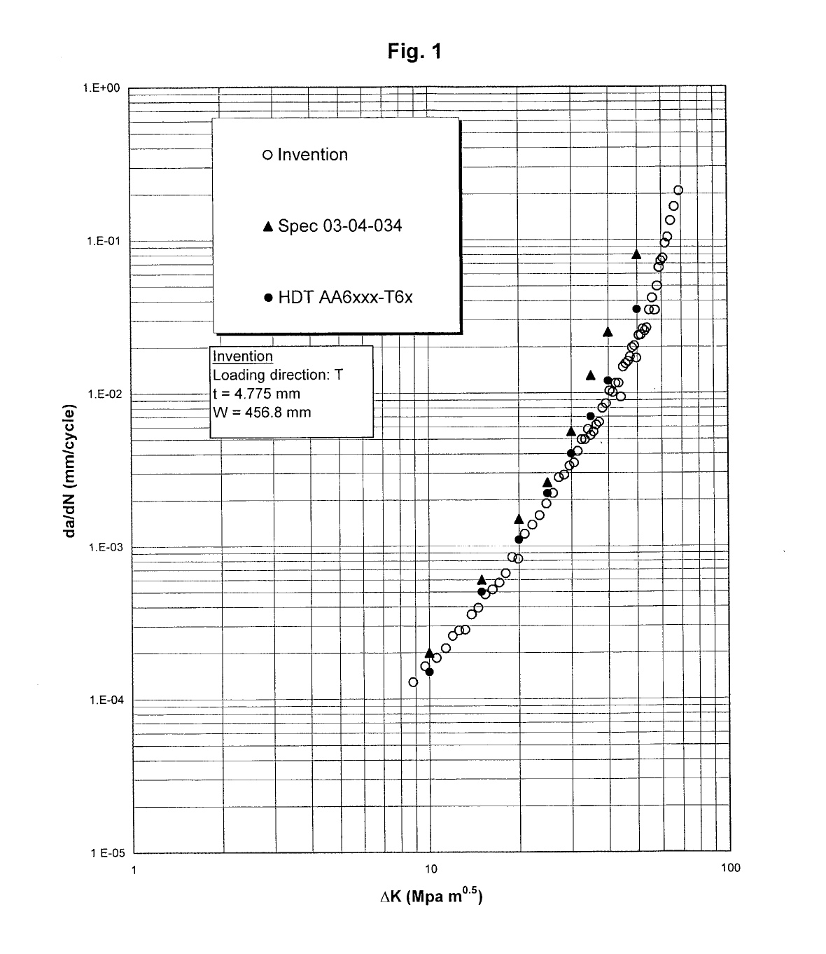

In addition the fatigue crack growth propagation (“FCGR”) has been measured in accordance with ASTM-E647, using CCT specimen, W=400 mm, 2ai=4.0 mm and R=0.1. The environmental conditions were at a temperature of 17 to 20° C., with a mean of 18.1° C., and a relative humidity of 33 to 53%, with a mean of 43%. The industry requirements for damage tolerant AA6xxx-series aluminium alloys in T62 temper is given in Table 6, and can be found e.g. in AIMS 03-04-034, issue 3A, section 71, and there is a trend for even higher demands which is also given in Table 6 as high damage tolerance AA6xxx-T6x (“HDT AA6xxx T6x”). The results for the sheet having a composition according to the invention have been plotted in FIG. 1 together to the industry standard set out in AIMS 03-04-034, issue 3A and the trend for high damage tolerance 6xxx-series alloys in an T6 temper.

From the results of the intergranular corrosion testing and stress corrosion testing it can be seen that the inventive alloy has a particular good intergranular corrosion resistance and also a good resistance against stress corrosion. From the results shown in FIG. 1 it can be seen that the panel according to the invention has a FCGR meeting the present industry standard, and also meets the requirements according to the trend.

Having now fully described the invention, it will be apparent to one of ordinary skill in the art that many changes and modifications can be made without departing from the spirit or scope of the invention as herein described.

TABLE 1
Chemical composition of the alloys tested.

| | Alloying element (wt. %) | | | | | | | |
|---|---|---|---|---|---|---|---|---|
| Alloy | Si | Fe | Cu | Mn | Mg | Zn | Ti | Siₐᵥ |
| 1 (inv.) | 1.05 | 0.19 | 0.29 | 0.72 | 0.70 | 0.09 | 0.03 | 0.89 |
| 2 (comp) | 1.33 | 0.14 | 0.3 | 0.69 | 0.69 | 0.08 | 0.03 | 1.19 |
| 3 (comp) | 1.04 | 0.14 | 0.28 | 0.69 | 0.72 | 1.5 | 0.02 | 0.90 |
| 4 (inv.) | 1.14 | 0.17 | 0.47 | 0.72 | 0.68 | 0.15 | 0.10 | 0.99 |
| standard | 0.92 | 0.15 | 0.90 | 0.46 | 0.88 | 0.08 | 0.02 | 0.81 |
| 6056 | | | | | | | | |
| standard | 0.79 | 0.17 | 0.96 | 0.35 | 0.90 | 0.09 | 0.03 | 0.70 |
| 6013 | | | | | | | | |

TABLE 2
Tensile properties in the L-direction in T62-temper sheet material.

| | Rp | Rm | A50 | L-T TS |
|---|---|---|---|---|
| Alloy | (MPa) | (MPa) | (%) | (Mpa) |
| 1 | 347 | 368 | 12 | 558 |
| 2 | 340 | 371 | 14 | 526 |
| 3 | 345 | 366 | 9 | 543 |
| 4 | 346 | 373 | 12 | 540 |
| standard 6056 | 362 | 398 | 12 | 601 |
| standard 6013 | 369 | 398 | 9 | 613 |

TABLE 3
ICG corrosion results in the T62-temper.

| Alloy | Depth of max. (μm) |
|---|---|
| 1 | 130 |
| 2 | 183 |
| 3 | 203 |
| 4 | 90 |
| standard 6056 | 177 |
| standard 6013 | 187 |

TABLE 4
Chemical composition of the alloy tested in Example 2.

| | Alloying element (wt. %) | | | | | | | |
|---|---|---|---|---|---|---|---|---|
| Alloy | Si | Fe | Cu | Mn | Mg | Zn | Ti | Siₐᵥ |
| 5 | 1.14 | 0.18 | 0.32 | 0.71 | 0.70 | 0.08 | 0.03 | 0.99 |

TABLE 5
Tensile properties in the L- and LT-direction
in the T62-temper sheet material.

| | Rp | | Rm | | A50 | |
|---|---|---|---|---|---|---|
| | (MPa) | | (MPa) | | (%) | |
| Alloy | L | LT | L | LT | L | LT |
| 5 | 329 | 317 | 342 | 353 | 9.4 | 9.8 |

TABLE 6
The crack propagation rates according to ASTM-E 647
should not be greater than the following date.

| CCT specimen, W = 400 mm, | | | |
|---|---|---|---|
| 2ai = 4.0 mm | | | |
| ΔK | | AIMS | HDT |
| [MPa · √m] | R | 03-04-034 | AA6xxx T62 |
| 20 | 0.1 | 1.5E−03 | 1.10E−03 |
| 25 | 0.1 | 2.6E−03 | 2.20E−03 |
| 30 | 0.1 | 5.6E−03 | 4.00E−03 |
| 35 | 0.1 | 1.3E−0.3 | 7.00E−03 |
| 40 | 0.1 | 2.5E−02 | 1.20E−02 |
| 50 | 0.1 | 8E−02 | 3.50E−02 |

1. Weldable, high-strength aluminum alloy rolled product containing the elements, in weight percent:
Si 0.8-1.3
Cu 0.2-0.45
Mn 0.5-1.1
Mg 0.45-1.0
Fe 0.01-0.3
Zr <0.25
Cr <0.25
Zn <0.35
Ti <0.25
V <0.25
others each <0.05, total <0.15
balance aluminum,
and with the proviso that the weight percent of available Si is in the range of 0.86 to 1.15.

2. Product in accordance with claim 1, wherein the Si level is in the range of 1.0 to 1.15.

3. Product in accordance with claim 1, wherein the available Si is in the range of 0.86 to 1.05.

4. Product in accordance with claim 1, wherein the Cu level is in the range of 0.3 to 0.45.

5. Product in accordance with claim 1, wherein the Mn level is in the range of 0.65 to 0.78.

6. Product in accordance with claim 1, wherein the Mg level is in the range of 0.6 to 0.85.

7. Product in accordance with claim 1, wherein the Mg level is in the range of 0.6 to 0.75.

8. Product in accordance with claim 1, wherein the Zn level is in the range of <0.2.

9. Product in accordance with claim 1, wherein the Ti level is in the range of 0.06 to 0.2.

10. Product in accordance with claim 1, wherein the Ti level is in the range of 0.07 to 0.16.

11. Product in accordance with claim 1, wherein the Fe level is in the range of 0.01 to 0.25.

12. Product in accordance with claim 1, wherein the Fe level is in the range of 0.01 to 0.2.

13. Product is accordance with claim 1, wherein the product has a more than 80% recrystallised microstructure.

14. Product is accordance with claim 1, wherein the product has a more than 90% recrystallised microstructure.

15. Product in accordance with claim 1, wherein the alloy product has been aged to an T6 temper in an ageing cycle which comprises exposure to a temperature of between 150 and 210° C. for a period between 0.5 and 30 hours, to thereby produce an aluminum alloy product characterized by an intergranular corrosion after an MIL-H-6088 test is present to a depth less than 180 μm.

16. Product in accordance with claim 1, wherein the alloy product has been aged to an T6 temper in an ageing cycle which comprises exposure to a temperature of between 150 and 210° C. for a period between 0.5 and 30 hours, to thereby produce an aluminum alloy product characterized by an intergranular corrosion after an MIL-H-6088 test is present to a depth less than 150 μm.

17. Product in accordance with claim 1, wherein the alloy product has a single or multiple cladding thereon of the following:
(i) it is of a higher purity aluminum alloy than said product;
(ii) the cladding is of the Aluminum Association AA1000-series;
(iii) the cladding is of the Aluminum Association AA4000-series;
(iv) the cladding is of the Aluminum Association AA6000-series;
(v) the cladding is of the Aluminum Association AA7000-series.

18. Product in accordance with claim 1, wherein the alloy product has a cladding thereon on one side of the Aluminum Association AA1000-series and on the other side thereon of the Aluminum Association AA4000-series.

19. Product according to claim 1, wherein the product is a structural component of an aircraft.

20. Product according to claim 1, wherein the product is aircraft skin material.

21. Product according to claim 1, wherein the product is aircraft skin material having a thickness of not more than 15 mm.

22. Product according to claim 1, wherein the product is an aircraft fuselage skin material.

23. Product according to claim 22, wherein the product is an aircraft fuselage skin material having a thickness of not more than 15 mm.

24. A method of producing the weldable, high-strength alloy product according to claim 1, comprises the sequential process steps of:
(a) providing stock having a chemical composition containing the elements, in weight percent, Si 0.8 to 1.3, Cu 0.2 to 0.45, Mn 0.5 to 1.1, Mg 0.45 to 1.0, Fe 0.01 to 0.3, Zr<0.25, Cr<0.25, Zn<0.35, Ti<0.25, V<0.25, others each <0.05 and total <0.15, balance aluminum, and further with the proviso that the weight percent of “available Si” is in the range of 0.86 to 1.15, and wherein the weight percentage (“wt. %”) of “available Si” is calculated according to the equation: wt. % Si(available)=wt. % Si−(wt. % Fe+wt. % Mn)/6,
(b) preheating or homogenizing the stock,
(c) hot rolling the stock,
(d) optionally cold rolling the stock,
(e) solution heat treating the stock,
(f) quenching the stock to minimize uncontrolled precipitation of secondary phases, and
(g) ageing the quenched stock to provide a product in a T4 temper or in a T6 temper.

25. Method according to claim 24, wherein the homogenization treatment during step (b) is carried out at a temperature in the range of 490 to 580° C.

26. Method according to claim 25, wherein the homogenization treatment during step (b) is carried out at a temperature in the range of 540 to 580° C.

27. Method according to claim 24, wherein the preheating during step (b) is carried out at a temperature in the range of 535 to 560° C. with a soaking time in the range of 4 to 16 hours.

28. Method according to claim 24, wherein the product during step (e) is being solution heat treated at a temperature in the range of 480 to 590° C. with a soaking time in the range of 10 sec. to 120 min.

29. Method according to claim 28, wherein the product during step (e) is being solution heat treated at a temperature in the range of 530 to 570° C. with a soaking time in the range of 10 sec. to 120 min.

30. Method according to claim 24, wherein the product is during step (g) naturally aged to provide a T4 condition.

31. Method according to claim 24, wherein the product is during step (g) artificially aged to provide a T6 condition.

32. Method according to claim 31, wherein the product is during step (g) artificially aged to provide a T6 condition, and whereby the alloy product is subjected to an ageing cycle comprising exposure to a temperature in the range of 150 to 210° C. for a period in the range of 30 min. to 30 hours.
